(19) United States
(12) Patent Application Publication
(10) Pub. No.: US 2008/0082361 A1
(43) Pub. Date: Apr. 3, 2008

(54) Adverse Treatment Event Management System

(75) Inventor: Michelle Marge, Landenberg, PA (US)

Correspondence Address: SIEMENS CORPORATION;INTELLECTUAL PROPERTY DEPARTMENT, 170 WOOD AVENUE SOUTH, ISELIN, NJ, 08830, US

(73) Assignee: SIEMENS MEDICAL SOLUTIONS USA, INC., Malvern, PA (US)

(21) Appl. No.: 11/862,569

(22) Filed: Sep. 27, 2007

Related U.S. Application Data
(60) Provisional application No. 60/827,765, filed on Oct. 2, 2006.

(51) Int. Cl. G06Q 50/00

(52) U.S. Cl. 705/2

(57) ABSTRACT

A system provides clinicians with real-time adverse drug event or reaction alerts for a patient by evaluating patient information to determine if a patient is experiencing an actual or potential adverse drug event or reaction to a medication. A system manages adverse treatment events using an acquisition processor for dynamically compiling adverse medication event data indicating particular medical symptoms associated with administration of corresponding particular medications to patients by acquiring adverse medication event indicative data from multiple different sources. A data processor automatically, monitors data sources employed by a clinical information system to identify data indicating medical symptoms of a particular patient and compares the medical symptoms of the particular patient with medical symptoms in the dynamically compiled adverse medication event data to identify matching symptoms. The data processor also automatically applies decision criteria for use in declaring an adverse treatment event for the particular patient in response to a comparison. A communication processor, in response to a declaration of an adverse treatment event for the particular patient, initiates generation of an alert message indicating the adverse treatment event.

This is a non-provisional application of provisional application Ser. No. 60/827,765 filed Oct. 2, 2006, by M. Marge.

### FIELD OF THE INVENTION

This invention concerns a system for managing and identifying adverse treatment events indicating particular medical symptoms associated with medications and generating alert messages indicating adverse treatment events.

### BACKGROUND OF THE INVENTION

Adverse Drug Events (ADE) are typically more common in a patient population than clinicians report, and since most ADEs do not cause permanent harm or death, many ADEs may occur unnoticed. Unrecognized and unreported ADEs increase likelihood of future events and errors and may impair patient safety. Likelihood of a failure to recognize or report ADEs is increased by multiple factors. These factors include, nursing shortage, lack of trust in technology, introduction of new medications and difficulty in obtaining ADE information concerning a particular medication. A shortage of clinicians at patient bedsides causes longer shifts or increased patient to nurse ratios and both impede the ability for a clinician to potentially recognize an ADE. Further, as smart technology is applied it enhances clinician trust in technology (e.g., in a medication order alert system). Sophisticated alert systems assist in preventing ADES, but over-alerting during medication ordering, for example, may cause potential ADEs to go unreported. Further, a clinician may expect medications to have been evaluated extensively and may overlook small signs of an ADE. Also new medications are constantly being introduced and clinicians have limited ability to keep up to date with new medication current side effect information.

In addition, if an ADE is not recognized quickly (e.g., in real-time) a clinician needs to search a variety of sources to extract data concerning an adverse effect of a medication a patient is experiencing. The sources include, for example, medication order records, medication administration records, nursing assessments, progress notes, history and physicals information and laboratory test results. Additionally, voluntary reporting of ADEs is often inadequate and poorly monitored, so changing ADE reporting operation may be a difficult process. Also the reporting of Drug Reactions by a patient conversely, may be used for an entirely different purpose, but faces similar problems as ADEs. The reporting of drug reactions a patient is experiencing assists a pharmaceutical organization in determining side effects for medications, and if reported in large quantities may cause a pharmaceutical organization to further investigate a potentially serious or prevalent side effect and result in medication recalls.

Even with data electronically captured, the process of evaluating and analyzing data to determine medication adverse drug events or reactions is typically manual. Some known systems use a predefined list of criteria to determine an ADE may have occurred. For example, such criteria may comprise data indicating predetermined events including, the ordering of a known antidote, decreasing dosage of medication or ordering specific laboratory tests. Known systems use these predetermined events as triggers to manually determine from reports if an ADE occurred. Known systems rely on clinician experience, thoroughness, and ability to stay up to date on articles, and medication side effects. This can cause a variety of inconsistent practices between providers in an institution or department. A system according to invention principles addresses these deficiencies and related problems.

### SUMMARY OF THE INVENTION

A system provides clinicians with real-time, potential or actual, adverse drug event or reaction alerts for a patient and prompts an appropriate clinician to further evaluate patient clinical condition and assist in reporting a drug event or reaction to a supervisory authority. A system manages adverse treatment events using an acquisition processor for dynamically compiling adverse medication event data indicating particular medical symptoms associated with administration of corresponding particular medications to patients by acquiring adverse medication event indicative data from multiple different sources. A data processor automatically, monitors data sources employed by a clinical information system to identify data indicating medical symptoms of a particular patient and compares the medical symptoms of the particular patient with medical symptoms in the dynamically compiled adverse medication event data to identify matching symptoms. The data processor also automatically applies decision criteria for use in declaring an adverse treatment event for the particular patient in response to a comparison. A communication processor, in response to a declaration of an adverse treatment event for the particular patient, initiates generation of an alert message indicating the adverse treatment event.

### BRIEF DESCRIPTION OF THE DRAWING

FIG. 1 shows a system for managing adverse treatment events, according to invention principles.

FIG. 2 shows a system architecture for managing adverse treatment events, according to invention principles.

FIG. 3 shows a flowchart of a process performed by a system for managing adverse treatment events, according to invention principles.

FIG. 4 shows a flowchart of a further process performed by a system for managing adverse treatment events, according to invention principles.

### DETAILED DESCRIPTION OF THE INVENTION

A system provides clinicians with real-time adverse drug reaction and event alert messages for a patient and evaluates patient information to determine if a patient is experiencing an actual or potential adverse drug event or reaction to a medication. If an adverse drum event or reaction is detected, the system alerts an appropriate clinician to further evaluate patient clinical condition and assist in reporting the drug event or reaction to a supervisor.

A processor, as used herein, operates under the control of an executable application to (a) receive information from an input information device, (b) process the information by manipulating, analyzing, modifying, converting and/or transmitting the information, and/or (c) route the information to an output information device. A processor may use, or comprise the capabilities of, a controller or microprocessor, for examples. The processor may operate with a display processor or generator. A display processor or generator is a known element for generating signals representing display images or portions thereof. A processor and a display processor may comprise a combination of, hardware, firmware, and/or software.

An executable application, as used herein, comprises code or machine readable instructions for conditioning the processor to implement predetermined functions, such as those of an operating system, a context data acquisition system or other information processing system, for example, in response to user command or input. An executable procedure is a segment of code or machine readable instruction, sub-routine, or other distinct section of code or portion of an executable application for performing one or more particular processes. These processes may include receiving input data and/or parameters, performing operations on received input data and/or performing functions in response to received input parameters, and providing resulting output data and/or parameters. A user interface (UI), as used herein, comprises one or more display images, generated by a display processor and enabling user interaction with a processor or other device and associated data acquisition and processing functions.

The UI also includes an executable procedure or executable application. The executable procedure or executable application conditions the display processor to generate signals representing the UI display images. These signals are supplied to a display device which displays the image for viewing by the user. The executable procedure or executable application further receives signals from user input devices, such as a keyboard, mouse, light pen, touch screen or any other means allowing a user to provide data to a processor. The processor, under control of an executable procedure or executable application, manipulates the UI display images in response to signals received from the input devices. In this way, the user interacts with the display image using the input devices, enabling user interaction with the processor or other device. The functions and process steps herein may be performed automatically or wholly or partially in response to user command. An activity (including a step) performed automatically is performed in response to executable instruction or device operation without user direct initiation of the activity. Workflow comprises a sequence of tasks performed by a device or worker or both. An object or data object comprises a grouping of data, executable instructions or a combination of both or an executable procedure.

A workflow processor, as used herein, processes data to determine tasks to add to a task list, remove from a task list or modifies tasks incorporated on, or for incorporation on, a task list. A task list is a list of tasks for performance by a worker or device or a combination of both. A workflow processor may or may not employ a workflow engine. A work low engine, as used herein, is a processor executing in response to predetermined process definitions that implement processes responsive to events and event associated data. The workflow engine implements processes in sequence and/or concurrently, responsive to event associated data to determine tasks for performance by a device and or worker and for updating task lists of a device and a worker to include determined tasks. A process definition is definable by a user and comprises a sequence of process steps including one or more, of start, wait, decision and task allocation steps for performance by a device and or worker, for example. An event is an occurrence affecting operation of a process implemented using a process definition.

A Workflow Management System is a software system that manages processes. It includes a process definition function that allows users to define a process that should be followed, an Event Monitor, which captures events from a Healthcare Information System and communicates the results to the Workflow Management System. A processor in the Management System tracks which processes are running, for which patients, and what step needs to be executed next, according to a process definition. The Management System includes a procedure for notifying clinicians of a task to be performed, through their worklists (task lists) and a procedure for allocating and assigning tasks to specific users or specific teams. A document or record comprises a compilation of data in electronic form and is the equivalent of a paper document and may comprise a single, self-contained unit of information.

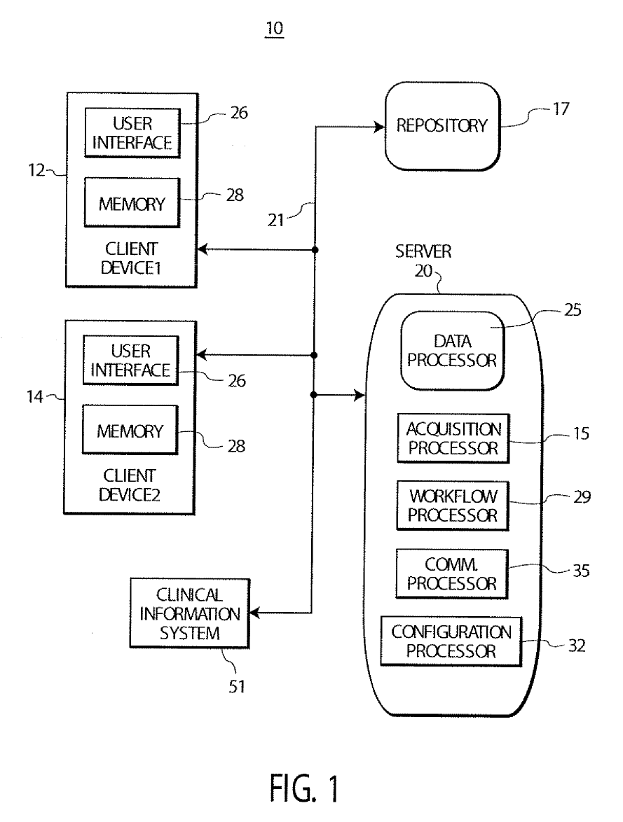

FIG. 1 shows system 10 for managing adverse treatment events. System 10 includes client devices (workstations) 12 and 14, repository 17, clinical information system 51 and server 20 bidirectionally communicating via network 21. Server 20 includes data processor 25, workflow processor 29, acquisition processor 15, configuration processor 37 and communication processor 35. Acquisition processor 15 dynamically compiles adverse medication event data indicating particular medical symptoms associated with administration of corresponding particular medications to patients by acquiring adverse medication event indicative data from multiple different sources. Data processor 25 automatically monitors data sources employed by a clinical information system to identify data suggestive of particular medical symptoms of a particular patient in response to clinical data of the particular patient. Data processor 25 automatically interrogates a medical record of the particular patient to identify recorded medical symptoms of the particular patient compatible with the particular medical symptoms. Data processor 25 also automatically compares the medical symptoms of the particular patient with medical symptoms in the dynamically compiled adverse medication event data to identify matching symptoms and applies decision criteria for use in declaring an adverse treatment event for the particular patient in response to a symptom comparison. Communication processor 35, in response to a declaration of an adverse treatment event for the particular patient, initiates generation of an alert message indicating the adverse treatment event. Workflow processor 29 automatically adds a task to a task list of a healthcare worker in response to, declaration of an adverse treatment event for the particular patient.

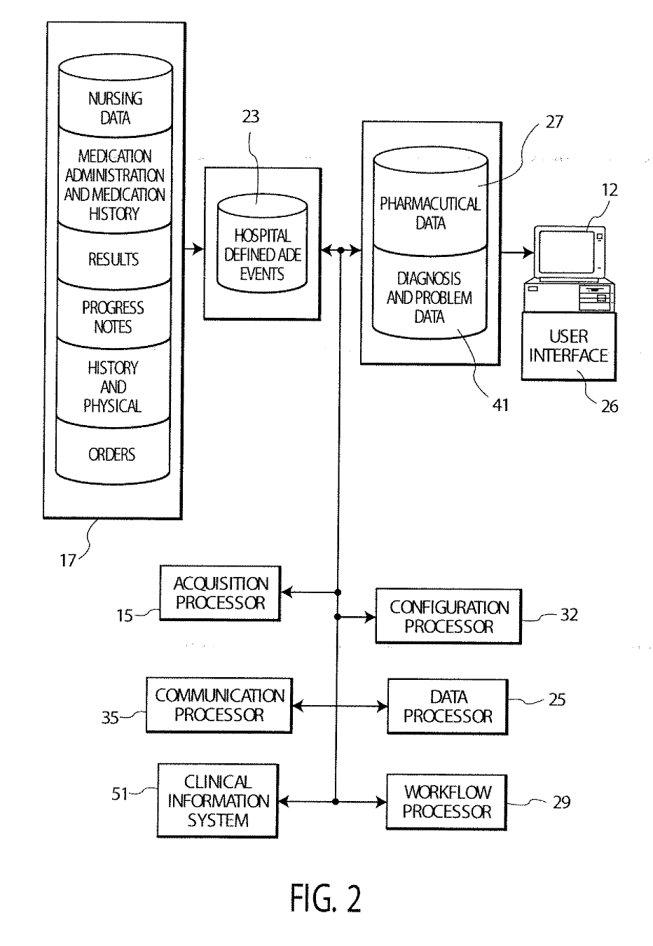

FIG. 2 shows an architecture of system 10 for managing adverse treatment events. Acquisition processor 15 dynamically compiles adverse medication event data indicating particular medical symptoms associated with administration of corresponding particular medications to patients. Processor 15 acquires adverse medication event indicative data from multiple different sources. The different sources include a repository (a first source) of pharmaceutical organization information concerning side effects of medications 27 and a second source, repositories 17 and 41, comprising user determined information and diagnosis and problem data, respectively. Repository 17 includes physician entered medication order data, nursing data, laboratory test results, progress notes, history and physical data and medication administration and medication history data. Acquisition processor 15 acquires and merges adverse medication event indicative data from repositories 17, 27 and 41.

Data processor 25 parses and analyzes patient data acquired from repositories 17, 27 and 41 and extracts specific relevant clinical data that may be associated with an adverse drug event or reaction. Data processor 25 does this by cross referencing a documented pharmaceutical side effect and reaction information with actual (and anticipated) signs and symptoms of a patient problem and diagnosis to statistically determine if a patient is experiencing an adverse drug event or reaction.

For this purpose data processor 25 uses hospital configured adverse medication event indicative data in repository 23. In response to data processor 25 determining a patient may be experiencing an adverse drug event or reaction, generation of a real-time alert message for communication to an appropriate clinician is initiated by communication processor 35. A clinician evaluates and validates the patient is experiencing an adverse drug event, or is experiencing a reaction to the medication and generates a report.

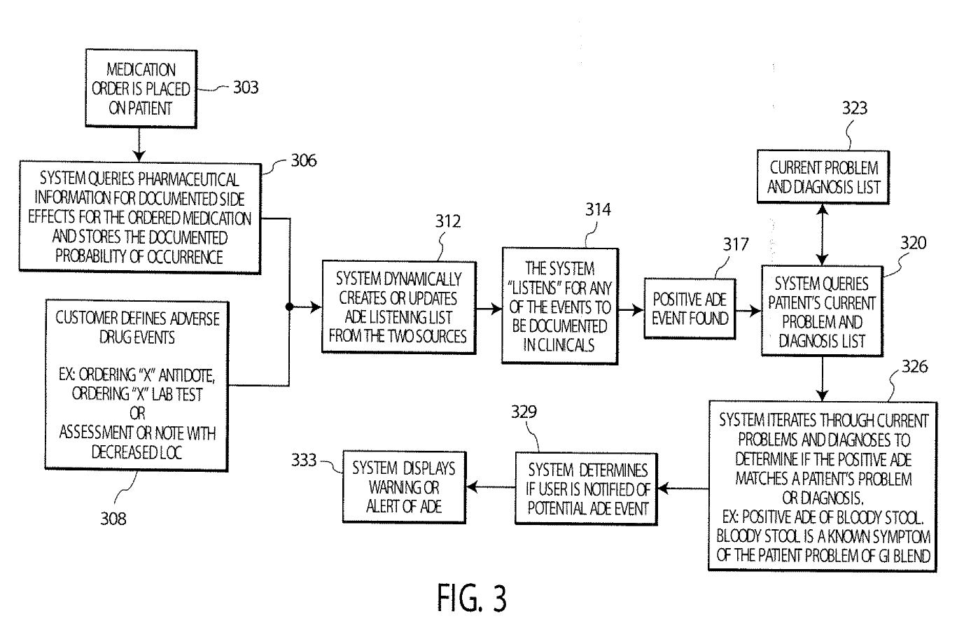

FIG. 3 shows a flowchart of a process performed by system 10 for managing adverse treatment events. In response to detection of an order for a patient to be administered a medication, in step 303, data processor 25 in step 306, automatically interrogates pharmaceutical organization information concerning documented side effect symptoms of the ordered medication and associated probability of occurrence stored in repository 27 (FIG. 2). A healthcare provider organization employs configuration processor 32 to configure system 10 so that a detected particular adverse dug event of a particular medication having a probability exceeding a particular threshold probability initiates alert message generation. A healthcare provider organization in step 308 configures system 10 by determining a list of Adverse Drug Events (ADEs) (e.g., ordering a particular antidote, or laboratory test or alteration of text in plan of care, or progress note or patient medical assessment). In step 312, data processor 25 automatically dynamically creates and updates an ADE source (listening) list based on the configured ADE list provided in step 308 and the user determined ADEs provided in step 306. Specifically data processor 25 dynamically creates and updates a list of sources to be interrogated and monitored for information indicating occurrence of one or more particular side effect symptoms of the ordered medication.

In step 314, data processor 25 monitors (listens) for information indicative of ADEs associated with the ordered medication of the patient available at sources in a clinical information system indicated by the configured list of sources. In another embodiment data processor 25 actively intermittently interrogates the configured list of sources for the information indicative of ADEs. In response to detection by data processor 25 of an ADE event in step 317, data processor 25 in step 320 interrogates a current patient medical problem and diagnosis list 323 (repository 41 FIG. 2) in a medical record of the patient to identify recorded medical symptoms of the patient compatible with particular side effect medical symptoms predetermined in step 306. Data processor 25 iterates through items in the current patient medical problem and diagnosis list 323 in step 326 and compares the medical symptoms of the patient with medical symptoms in dynamically compiled adverse medication event data to identify matching symptoms. Data processor 25 applies decision criteria for use in declaring an adverse treatment event for a patient by determining symptoms match based on a text and word comparison and by determining the matching symptoms are indicative of an adverse event for a particular medication and particular patient. Data processor 25 considers pharmaceutical data derived from repository 27 patient medical history, problems an diagnosis data from repository 41 and physical and demographic characteristics from repository 17 and other sources in determining a symptom has a probability exceeding a predetermined particular threshold probability for designation of an ADE event and initiation of alert message generation. For example, data processor 25 detects an ADE event (e.g., blood in stool indicative of gastrointestinal bleeding).

In step 329, communication processor 35 determines in response to predetermined configuration information, whether a user is to be notified of the detected adverse medication event. Configuration processor 32 (FIG. 1) is employed by a user to predetermine if an alert message is to be communicated to a user in response to a detected adverse medication event or whether an alert is to be suppressed. In step 333, in response to a declaration of an adverse treatment event for a particular patient, communication processor 35 initiates generation of an alert message indicating the adverse treatment event and communicates the alert message to a user. In one embodiment, the alert message is displayed on workstation 12. In other embodiments, the alert message is provided to a phone, pager or fixed or portable processing device of a user. Further, workflow processor 29 adds a task list to a healthcare worker or device in response to the detected adverse medication event. The process of FIG. 3 facilitates the documentation and reporting of an ADE event or reaction and accelerates detection of a need for drug (medication) recalls or investigational studies. In contrast, known systems fail to review and analyze an entire patient medication, diagnostic history and pharmaceutical data in addition to current data to assist in adverse drug event/reaction detection.

Data processor 25 automatically searches for and analyses data, to provide a clinician with alert messages indicating potential ADEs or Drug Reactions. Specifically, data processor 25 searches through current and past patient medication data to derive symptom related data indicative or potentially indicative of an adverse drug event or reaction. A user employs configuration processor 32 to determine events which suggest a higher probability of an ADE occurring. Events include, for example, over sedation, ordering of a particular antidote, decrease of medication dosage, ordering of a particular laboratory test, transfer of a patient to a higher level of care, ordering of antiemetics and abrupt discontinuation of medication. Data processor 25 employs a Pharmaceutical and Problem and Diagnosis cross reference in repositories 27 and 41 (FIG. 2) to cross reference documentation of expected side effects of medications and patient documented problems and diagnoses.

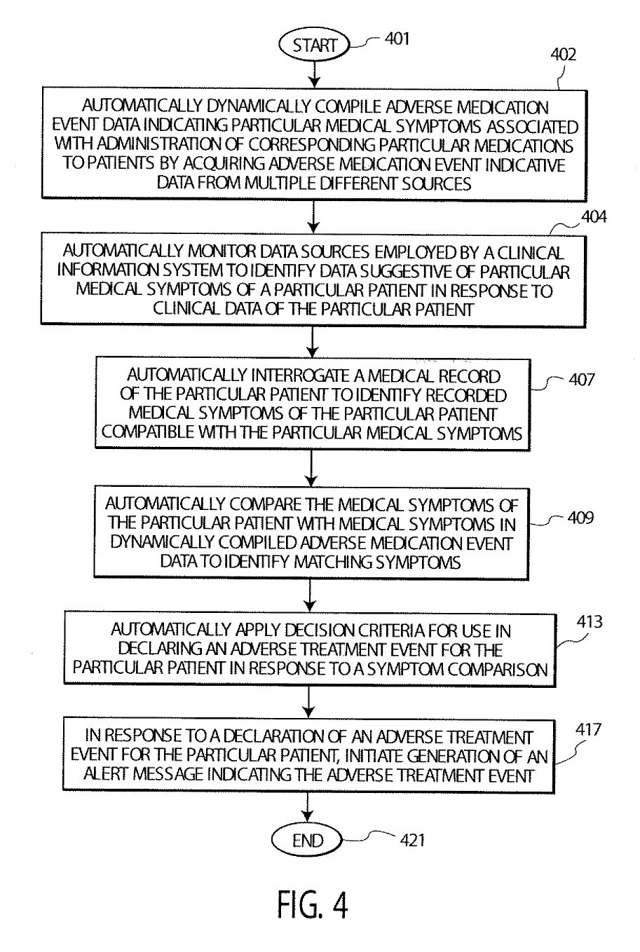

FIG. 4 shows a flowchart of a further process performed by system 10 for managing adverse treatment events. The steps of FIG. 4 may be performed automatically. In step 402 following the start at step 401, acquisition processor 15 dynamically compiles adverse medication event data indicating particular medical symptoms associated with administration of corresponding particular medications to patients by acquiring adverse medication event indicative data from multiple different sources. Dynamically compiled adverse medication event data indicates particular medical symptoms associated with side effects experienced by a proportion of a population of patients. Acquisition processor 15 acquires adverse medication event indicative data from a first source of pharmaceutical organization information concerning side effects of medications (e.g., repository 27 FIG. 2) in response to detection of an order for the particular medication to be administered to the particular patient and a second source comprising user determined information (e.g., repositories 17 and 41 FIG. 2). Acquisition processor 15 acquires and merges adverse medication event indicative data from the first source and the second source.

Data processor 25 in step 404 automatically monitors data sources employed by a clinical information system 51 (e.g., repositories 17 and 41) to identify data suggestive of (indicating or potentially indicating) particular medical symptoms of a particular patient in response to clinical data of the particular patient. Clinical information system 51 is an executable application comprising at least one of, (a) a treatment ordering system, (b) a scheduling system, (c) a patient administration system, (d) a pharmacy system and (e) a laboratory information system. The clinical data of the particular patient comprises one or more of, a laboratory test result, a documented assessment of medical condition of the particular patient and documentation of a medical image interpretation. Data processor 75 in step 407 automatically interrogates a medical record of the particular patient to identify recorded medical symptoms of the particular patient compatible with the particular medical symptoms.

Data processor 25 in step 409 automatically compares medical symptoms of the particular patient with medical symptoms in dynamically compiled adverse medication event data to identify matching symptoms. In step 413, data processor 25 applies decision criteria for use in declaring an adverse treatment event for the particular patient in response to a symptom comparison e.g. by determining a likelihood of an adverse treatment event for the particular patient exceeds a predetermined threshold. Adverse treatment event determination criteria comprises a statistical determination a likelihood of an adverse treatment event for the particular patient exceeds a predetermined threshold. In step 417, in response to a determination an adverse treatment event for the particular patient exceeds a predetermined threshold and declaration of an adverse treatment event for the particular patient, communication processor 35 initiates generation of an alert message indicating the adverse treatment event. FIG. 4 terminates at step 421.

The system and processes of FIGS. 1-4 are not exclusive. Other systems, processes and menus may be derived in accordance with the principles of the invention to accomplish the same objectives. Although this invention has been described with reference to particular embodiments, it is to be understood that the embodiments and variations shown and described herein are for illustration purposes only. Modifications to the current design may be implemented by those skilled in the art, without departing from the scope of the invention. System 10 is applicable for patient self-monitoring of ADE (Adverse Drug Events) in a home point of care setting as well as in a hospital setting. System 10 employed in home care notifies a clinician if an ADE event is captured at home and reduces need for patient admission to a hospital or an emergency room visit. The processes and applications may in alternative embodiments, be located on one or more (e.g., distributed) processing devices accessing a network linking the elements of FIG. 1. Further, any of the functions and steps provided in FIGS. 1-4 may be implemented in hardware, software or a combination of both and may reside on one or more processing devices located at any location of a network linking the elements of FIG. 1 or another linked network including the Internet.

The system is applicable for patient self-monitoring of ADE (Adverse Drug Events) in a home point of care setting. Home Care systems may be expanded to notify practitioners if ADE events are captured at home. The system facilitates prevention of admissions or ER visits.

What is claimed is:

1. A system for managing adverse treatment events, comprising:
an acquisition processor for dynamically compiling adverse medication event data indicating particular medical symptoms associated with administration of corresponding particular medications to patients by acquiring adverse medication event indicative data from a plurality of different sources;
a data processor for automatically,
monitoring data sources employed by a clinical information system to identify data indicating medical symptoms of a particular patient,
comparing said medical symptoms of said particular patient with medical symptoms in dynamically compiled adverse medication event data to identify matching symptoms and
applying decision criteria for use in declaring an adverse treatment event for said particular patient in response to a symptom comparison; and
a communication processor for, in response to a declaration of an adverse treatment event for said particular patient, initiating generation of an alert message indicating said adverse treatment event.

2. A system according to claim 1, wherein
adverse treatment event determination criteria comprises a statistical determination a likelihood of an adverse treatment event for said particular patient exceeds a predetermined threshold.

3. A system according to claim 1, wherein
dynamically compiled adverse medication event data indicates particular medical symptoms associated with side effects experienced by a proportion of a population of patients.

4. A system according to claim 1, wherein
said data processor monitors said data sources employed by said clinical information system to identify data potentially indicating particular medical symptoms of said particular patient in response to clinical data of said particular patient.

5. A system according to claim 1, wherein
said clinical data of said particular patient comprises at least one of, (a) a laboratory test result and (b) a documented assessment of medical condition of said particular patient.

6. A system according to claim 1, wherein
said clinical data of said particular patient comprises documentation of a medical image interpretation.

7. A system according to claim 1, wherein
said data processor automatically interrogates a medical record of said particular patient to identify recorded medical symptoms of said particular patient and compares said recorded medical symptoms of said particular patient with medical symptoms in said dynamically compiled adverse medication event data to identify said matching symptoms.

8. A system according to claim 1, wherein
said acquisition processor acquires adverse medication event indicative data from a first source of pharmaceutical organization information concerning side effects of medications and a second source comprising user determined information.

9. A system according to claim 8, wherein
said acquisition processor acquires and merges adverse medication event indicative data from said first source and said second source.

10. A system according to claim 1, wherein
said acquisition processor acquires adverse medication event indicative data from pharmaceutical organization information concerning side effects of a particular medication in response to detection of an order for said particular medication to be administered to said particular patient.

11. A system according to claim 1, wherein
said clinical information system is an executable application comprising at least one of, (a) a treatment ordering system, (b) a scheduling system, (c) a patient administration system, (d) a pharmacy system and (e) a laboratory information system.

12. A system for managing adverse treatment events, comprising:
an acquisition processor for dynamically compiling adverse medication event data indicating particular medical symptoms associated with administration of corresponding particular medications to patients by acquiring adverse medication event indicative data from a plurality of different sources;
a data processor for automatically,
monitoring data sources employed by a clinical information system to identify data suggestive of particular medical symptoms of a particular patient in response to clinical data of said particular patient,
interrogating a medical record of said particular patient to identify recorded medical symptoms of said particular patient compatible with said particular medical symptoms,
comparing said medical symptoms of said particular patient with medical symptoms in dynamically compiled adverse medication event data to identify matching symptoms and
applying decision criteria for use in declaring an adverse treatment event for said particular patient in response to a symptom comparison; and
a communication processor for, in response to a declaration of an adverse treatment event for said particular patient, initiating generation of an alert message indicating said adverse treatment event.

13. A system for managing adverse treatment events, comprising:
an acquisition processor for dynamically compiling adverse medication event data indicating particular medical symptoms associated with administration of corresponding particular medications to patients by acquiring and merging adverse medication event indicative data from a plurality of different sources;
a data processor for automatically,
monitoring data sources employed by a clinical information system to identify data indicating medical symptoms of a particular patient,
comparing said medical symptoms of said particular patient with medical symptoms in said dynamically compiled adverse medication event data to identify matching symptoms and
applying adverse treatment event determination criteria to determine a likelihood of an adverse treatment event for said particular patient exceeds a predetermined threshold; and
a communication processor for, in response to a determination an adverse treatment event for said particular patient exceeds said predetermined threshold, initiating generation of an alert message indicating said adverse treatment event.
